(19) United States
(12) Patent Application Publication
(10) Pub. No.: US 2003/0084092 A1
(43) Pub. Date: May 1, 2003

(54) Internet tibetan prayer wheel

(76) Inventor: Paul Elia Wilson, Chapel Hill, NC (US)

Correspondence Address: Paul Elia Wilson, 12 Ellen Pl., Chapel Hill, NC, 27514, US

(21) Appl. No.: 09/999,564

(22) Filed: Nov. 1, 2001

(51) Int. Cl. G06F 15/16

(52) U.S. Cl. 709/203

(57) ABSTRACT

An internet Tibetan prayer wheel and method of operation are disclosed. The device contains a Tibetan prayer wheel, an electric motor, a motor controller and a power supply. The motor controller is connected to a personal computer. The personal computer is connected to the internet through standard means. A remote computer on the internet sends a wheel turning signal to a server. The signal is later received by the personal computer to which the Tibetan prayer wheel is attached, causing the Tibetan prayer wheel to turn. The device enables creation of an internet web site where visitors may turn remotely-sited prayer wheels.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

1. Field of the Invention

The present invention relates to a Tibetan prayer wheel which may generally be classified as a Buddhist ritual object, meditation aid or religious artifact. In particular, the present invention relates to a Tibetan prayer wheel which is connected to a computer as a peripheral device, so that a user may variously control the prayer wheel, and so that a remote user through the medium of the internet may variously control the prayer wheel from a distant location. The present invention also relates to a method of operating said prayer wheel from a remote location through the medium of the internet.

2. Description of the Related Art

A Tibetan prayer wheel is a rotating cylinder onto which is inscribed the Tibetan Buddhist mantra “Om mani padme, hum!” which when translated into English means roughly “Praise to the jewel in the lotus, amen!” In addition to the external inscription, the interior of the rotating cylinder generally contains a paper or cloth scroll onto which is written the above Buddhist mantra.

Tibetan prayer wheels may be large or small. Many Buddhists use a personal, hand-held version of the prayer wheel in their daily life and communal religious structures generally have banks of larger wheels arranged along their exterior surfaces which passers-by set in motion. One generally recites the mantra when turning the prayer wheel. These religious devices have been used in Tibet and neighboring countries for many centuries. Those of the Buddhist faith believe that by turning the wheel and reciting the mantra, anonymous prayers are offered to the universe for the benefit of all beings.

Tibetan prayer wheels have been called the Wheel of the Law, the Wheel of Life and Death the Wheel of Transmigration, the Wheel of Time, the Royal Chariot Wheel of the Truth, the Supreme Wheel of the Empire of Truth, the Dharma Wheel, the Buddhist Praising-Wheel, the Great Wheel of Compassion, the Buddhist Praying-Wheel, the Mani Wheel, etc. Today, their used is largely restricted to Tibet, Nepal and neighboring countries, but there is much evidence of historical use in all Buddhist countries. Japanese versions of these devices often serve as a repository for sacred writings. Those skilled in the art of prayer wheel manufacture are typically Tibetan refugees now living in Nepal and India.

Virtual Tibetan prayer wheels are now available. For example, a computer screensaver program now exists which depicts an animated, rotating prayer wheel as does a program, written in the Java programming language, which displays a revolving Tibetan script. The program may be added to ones personal internet home page and viewed by computer users the world over. Yet another computer program places the mantra as a plurality of electrical charges on a computer's hard disk. As the hard disk turns, the mantra is thought to emanate for the benefit of all beings.

The more traditional, physical Tibetan prayer wheels have historically been powered by hand, by rising smoke, by the blowing wind and by moving water. Traditional, physical prayer wheels powered by electric motors have also been described. To date, however, traditional, physical Tibetan prayer wheels that are motorized, computer-controlled and remotely accessible through a computer network are unknown.

### BRIEF SUMMARY OF THE INVENTION

An object of the present invention is to provide a motorized Tibetan prayer wheel which is connected to a computer network (such as the internet) through means of a personal computer or related device so that it may be set into motion by a command originating from a remote location. Additional features and advantages of the invention will be set forth in the description which follows and will be apparent from the description, the claims hereof, the appended drawings or by practice of the invention.

To achieve these and other advantages, the present invention includes a base unit having an electronic motor controller connected to a communication line, a motor which turns a spindle and a source of electric power. The present invention also includes a cylinder in the form of a traditional Tibetan prayer wheel containing a mantra-inscribed scroll and various decorative markings. The cylinder may comprise any of many forms and shapes typical of traditional Tibetan prayer wheels, but the decorative cylinder of the present invention lacks a traditional handle. The motor controller responds to a change in the state of the communication line by releasing power from the power source to the motor, causing the motor, and the attached prayer wheel, to turn.

### BRIEF DESCRIPTION OF THE DRAWINGS

The accompanying drawings together with the written description provided will serve to explain the principles of the invention.

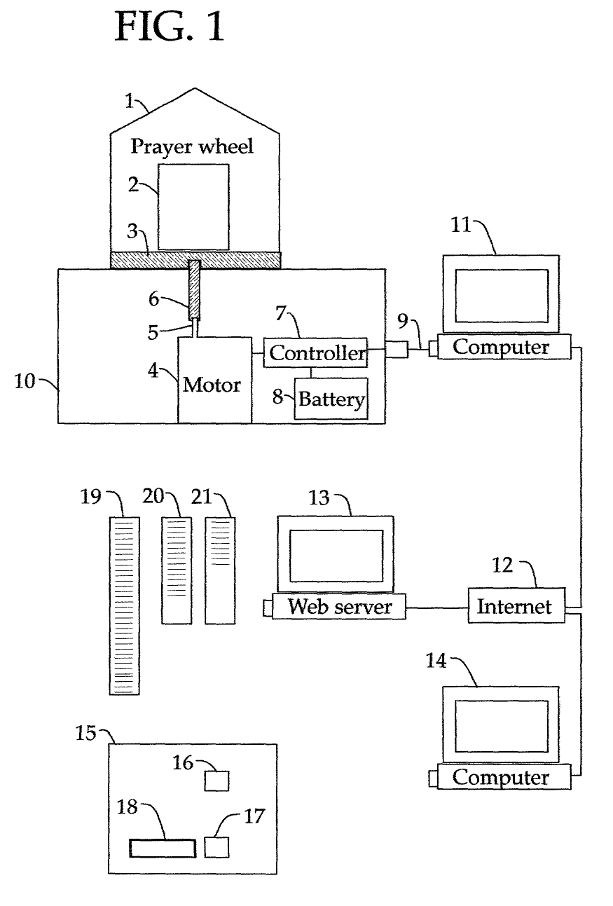

In the drawings, FIG. 1 is a block diagram showing a Tibetan prayer wheel according to the present invention wherein a wheel turning signal may originate from the local personal computer to which the prayer wheel is directly attached or from a remote computer connected to the local computer through a computer network such as the internet. The figure also illustrates wheel control through the medium of an internet web site.

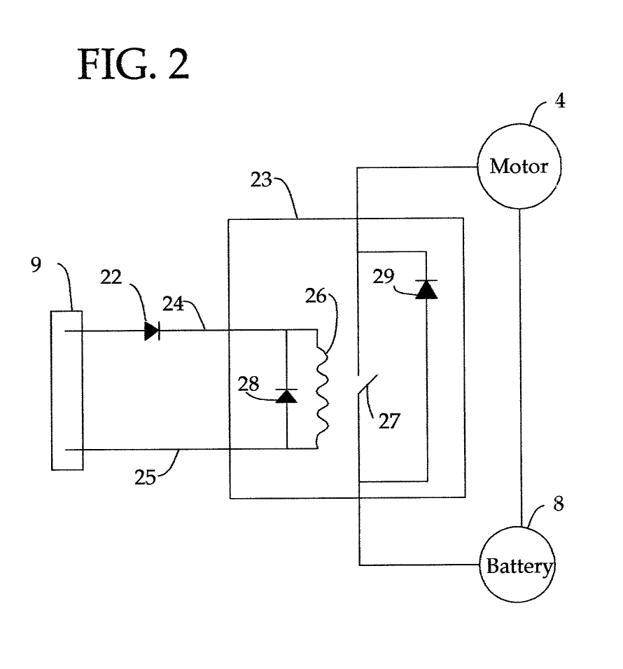

Also in the drawings, FIG. 2 shows the arrangement of electrical components used in the present invention to control wheel rotation.

### DETAILED DESCRIPTION OF THE INVENTION

It is to be understood that both the foregoing general description and the following detailed description are intended to be exemplary and explanatory of the invention as claimed. The embodiments described herein are not to be construed as limiting the present invention or the scope of the claims. Many alternatives, modifications, and variations will be apparent to those skilled both in the art of electro-mechanics and in prayer wheel manufacture. Reference will now be made in detail to the preferred embodiment of the present invention, an example of which is illustrated in the accompanying drawings.

As shown in FIG. 1, an Internet Tibetan prayer wheel according to the present invention includes a Tibetan prayer wheel cylinder (1) containing a traditional inscribed prayer scroll (2). The wheel may comprise any of many forms as deemed appropriate for traditional Tibetan prayer wheels. The wheel sits upon a turntable (3) which is turned by a direct current electric motor (4). The motor spindle (5) communicates with the turntable through shafting means (6). A motor controller (7) connects a power source such as a battery (8) to the motor (4). The entire assembly is contained in an electronics enclosure (10). The enclosure connects to a local computer (11) through a serial communications line (9). The local computer, as is typical, connects to the internet (12) and is thus connected to various remote web servers (13) which serve information as part of a network to other computers (such as 11 and 14).

The controller (7) is illustrated by FIG. 2, which depicts a reed-relay (23) which lies between the battery (8) and motor (4). The reed-relay contains an electromagnetic coil (26) and switch (27). It also supports a pair of diodes (28 and 29) across the coil and switch as is typical for such components. The computer's serial communications line (9) is connected to the reed-relay by a wire (24) from the RS232C Data Terminal Ready (DTR) pin on the serial communications line. A second wire (25) acts as a ground wire in the serial communication line. A diode (22) is provided to protect the computer's serial port.

In the disclosed embodiment, the motor (4) has five stages, a rated torque of 90 mN-m, a rated speed at 12 V of 64 rpm, a rated current of 170 mA, a no-load speed of 91 rpm at 12 V, a terminal resistance of 27 ohms and a gear ratio of approximately 57. The disclosed reed-relay (23) has a maximum switching voltage of 200 VDC, a maximal switching current of 1 amp, a nominal voltage of 12 VDC, a pick-up voltage of 9 VDC, a drop-out voltage of 1.2 VDC and a coil resistance of approximately 1200 ohms. The diodes across the reed-relay's coil and switch are of the 1N4004 type. The disclosed motor protecting diode (22) has a 1A forward current and a 50 ns switching speed. The battery (8) is a standard nine volt transistor battery.

Hereinafter, the operating method for the present invention will be explained with reference to FIG. 1 and FIG. 2. Data communication between the motor controller (7) and the local computer (11) is performed through the computer's serial communications line (9) using a protocol generally conforming to the well-recognized RS232C serial communications standard. The controller unit herein described contains a reed-relay (23) which is responsible for releasing power from the battery (8) to the motor (4). The release of power occurs when the voltage in the DTR wire (24) from the computer's serial communications line goes from its normal value of approximately −12 volts to approximately +12 volts with respect to an associated ground wire (25). With the release of power, the motor turns along with the prayer cylinder (1) to which it is connected.

The change in DTR wire (24) voltage is caused by software resident on the local computer (11), but the signal to turn may actually originate from a remote computer (14) connected to the local computer through an internet connection (12). Any of various computer programming languages may be used to alter the voltage in the DTR wire. In the embodiment disclosed herein, I use the Java programming language. Specifically, I use the freely-available JavaComm software package to gain access to the computer's serial port and to alter the voltage level in the DTR wire. Networking capabilities, a standard Java feature, are used to communicate with the web server. Any of various standard methods may be used to construct an internet web site (15) having the features and the capabilities described later herein. In the embodiment disclosed, web pages are written in the Hypertext Markup Language (html) and the Java programming language is used to write server-side software that receives and processes requests originating from the internet web site.

The embodiment above described entails data communication via an RS232 line. Other forms of communication between the host computer and motor controller are anticipated by the present invention and include, but are not limited to, data communication via infrared means, via cabling connected to a Universal Serial Bus (USB) port, via cabling connected to a parallel port, via cabling connected to a Small Computer System Interface (SCSI) port or cabling connected to any of various ports commonly found on personal computers. In the present invention, the power source is a nine volt transistor battery. In some cases, the communication line itself may provide power to the device.

Miniature direct current motors are commercially available and any of several models may serve in the present invention. The motor (4) herein disclosed is a small direct current motor of the type commonly used in electronic toys, office equipment and robotics devices. It is outfitted with a gearbox so as to reduce the final speed of the spindle (5) to approximately 60 revolutions per minute when connected to a nine volt battery. When provided with power, the spindle will turn at a speed compatible with motor's composition and the composition of its induded gearbox. A second embodiment may provide rotation at the required speed through use of a weak motor, having a stall torque rating barely sufficient to turn the required load. A third embodiment may provide rotation at the required speed by reducing the voltage supplied to the motor. A fourth embodiment may provide rotation at the required speed by providing pulses of voltaic power to the motor on an intermittent basis.

The motor controller (7) of the present invention contains a commercially available electromechanical switch in the form of a reed-relay having several internal diodes. Relays having opto-electronic or transistor means may also be used and are anticipated by the present invention as are more sophisticated commercial motor-control circuits.

Mode of Operation of the Invention

I will now explain how the Tibetan prayer wheel of the present invention may be operated through the medium of an internet web site. As shown in FIG. 1, a local computer (11) supports an internet Tibetan prayer wheel (1) according to the present invention. The local computer is connected to a web server (13) through means of an internet connection (12). The web server also serves a remote computer (14). Typically, such web servers service a plurality of remote computers through means of the internet network The web server presents an internet web site (15) which may be visited by computer users the world over. Among its many possible features, the internet web site supports two buttons (16 and 17) and a text field (18). Software residing on the web server accesses a database of information (19) pertaining to web-aware prayer wheels according to the present invention. The web server software also supports two lists (20 and 21).

When a web site user at a remote computer (e.g. 14) presses the button labeled as 16 in FIG. 1, a prayer wheel identity is selected randomly from the database (19) and is added to one of the lists (20). When a web site user enters a specific identity in the text field (18) and then presses the associated button (17), a prayer wheel identity is selected from the database (19) according to the information in the text field and is added to the second list (21). The local computer (11) queries the web server (13) on a regular basis through the internet connection (12). If the local computer finds itself named in either list (20 or 21), software residing on the local computer increases the voltage in the DTR wire (24) causing the attached prayer wheel (1) to turn.

The above presents one of several possible strategies for managing wheel turning invocations. Another common technique would be for the local computer to establish an internet connection and then transmit its Internet Protocol address to the web server. The web server could then send a wheel turn command directly to the local computer rather than as a response to a query. The scenario described above could be made more efficient if either of the two lists (20 and/or 21) were subject to advanced preparation. Such software schemes are often referred to as “cahing,” are familiar to those with appropriate computer programming skills, and are anticipated by the present invention. In addition, the graphical software controls presented on the web site page (15) may be substantially more elaborate than the simple buttons and text field disclosed herein by way of explanation.

The Tibetan prayer wheel, according to the present invention, does more than automate the well-known process of Tibetan prayer wheel turning. It is a significant improvement over the prior art as it enables creation of an international network of internet-aware Tibetan prayer wheels accessible from a central internet web site where visitors may set remotely-sited Tibetan prayer wheels in motion. Web site visitors do not have to posses a prayer wheel to participate and thus the present invention differs substantially from the prior art.

The traditional, religious and philosophical impetus for Tibetan prayer wheels is that, with each turn of the wheel, anonymous prayers are offered to the Universe for the benefit of all beings. It is the Buddhist belief, that those who turn prayer wheels do so out of compassion for others and that merit accrues in this life for those who set such wheels in motion. In the Buddhist tradition, such actions benefit all sentient beings. The present invention uniquely extends this tradition.

I claim,

1. A Tibetan prayer wheel turned by a computer-controlled electric motor.

2. A Tibetan prayer wheel as in claim 1 which is controlled by a computer that participates in a network of computers.

3. A Tibetan prayer wheel as in claim 2 which is controlled by a remote computer in a network of computers.

4. A Tibetan prayer wheel as in claim 2 where the network of computers in which the controlling computer participates is the internet.

5. A method of operating a Tibetan prayer wheel as in claim 4 comprising the steps of:
[a], presenting an internet web site where visitors may express a desire to turn a remote Tibetan prayer wheel;
[b], operating software which detects when a web site visitor expresses a desire to turn a wheel;
[c], operating software which receives turn invocations from a server computer and causes a prayer wheel to turn.
